(19) United States
(12) Patent Application Publication
(10) Pub. No.: US 2026/0210524 A1
(43) Pub. Date: Jul. 23, 2026

(54) CANOPY LIGHT

(71) Applicant: BRIGHTZ, LTD., Ottawa Lake, MI (US)

(72) Inventor: James MCALLISTER, Perrysburg, OH (US)

(21) Appl. No.: 19/451,413

(22) Filed: Jan. 16, 2026

Related U.S. Application Data
(60) Provisional application No. 63/746,392, filed on Jan. 17, 2025.

(51) Int. Cl. F21V 5/04; F21V 17/10; F21V 17/16; F21V 19/00; F21V 21/30; F21V 23/06; F21V 31/00; F21W 131/10; F21Y 113/00

(52) U.S. Cl. CPC F21V 5/04; F21V 17/101; F21V 17/162; F21V 19/0015; F21V 21/30; F21V 23/06; F21V 31/005; F21W 2131/10; F21Y 2113/00

(57) ABSTRACT

Disclosed is a lighting assembly for a canopy that provides dual-beam illumination capabilities for enhanced outdoor visibility and functionality. The lighting assembly includes a body extending between a first end and a second end opposite the first end, wherein the body defines a cavity, a first lens disposed in the cavity, a second lens disposed in the cavity at the first end of the body and defining a central opening, wherein the first lens is positioned in the central opening, a first light source configured to emit light through the first lens to provide a forward-facing spotlight, and a second light source configured to emit light through the second lens to provide a forward-facing floodlight.

### CROSS-REFERENCE TO RELATED APPLICATIONS

This application claims priority to and the benefit of U.S. Provisional Patent Application No. 63/746,392 filed on January 17, 2025, the disclosure of which is incorporated in its entirety.

### BACKGROUND

Illumination systems for outdoor applications, such as those used with canopies, tents, and temporary shelters, are known in the art for enhancing visibility and functionality during outdoor activities in low-light conditions. Traditional outdoor lighting systems typically include basic single-beam lights that provide limited illumination patterns and often suffer from inadequate attachment mechanisms, poor weather resistance, and limited operational flexibility. Furthermore, many existing lighting systems utilize rigid mounting brackets that are difficult to install, require specialized tools, and may not accommodate varying frame sizes and configurations.

The inflexibility and limitations of conventional outdoor lighting systems make them unsuitable for the variable conditions encountered during outdoor activities, including different weather conditions, lighting requirements, and usage environments. Poor attachment mechanisms and inadequate weather resistance can lead to component failure or detachment during use, thereby reducing visibility and compromising user functionality.

Thus, there is a need in the art for an improved outdoor lighting system that overcomes the drawbacks of conventional systems.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a lighting assembly for a canopy includes a body extending between a first end and a second end opposite the first end, wherein the body defines a cavity, a first lens disposed in the cavity, a second lens disposed in the cavity at the first end of the body and defining a central opening, wherein the first lens is positioned in the central opening, a first light source configured to emit light through the first lens to provide a forward-facing spotlight, and a second light source configured to emit light through the second lens to provide a forward-facing flood light.

According to another embodiment consistent with the present disclosure, a lighting assembly includes a body defining a cavity and including a connector defining a socket, a lens including a first portion and a second portion disposed in the cavity, wherein the second portion surrounds the first portion, a first light source arranged in the cavity and configured to emit light through the first portion, a second light source arranged in the cavity and configured to emit light through the second portion, and a mounting assembly including a ball joint positioned in the socket, thereby defining a joint, and a mounting bracket coupled to the ball joint.

According to a further embodiment consistent with the present disclosure, a lighting assembly includes a body defining a cavity, a lens including a first portion and a second portion disposed in the cavity, wherein the second portion surrounds the first portion, a first light source arranged in the cavity and configured to emit light through the first portion, and a second light source arranged in the cavity and configured to emit light through the second portion, wherein the first and second light sources are toggleable between a plurality of a power states, including a first power state in which the first light source emits light through the first portion and the second light source abstains from emitting light, a second power state in which the second light source emits light through the second portion and the first light source abstains from emitting light, a third power state in which the first and second light sources emit light through the first and second portions simultaneously, and a fourth power state in which the first and second light sources both abstain from emitting light.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE FIGURES

FIG. 1 illustrates a front isometric view of a lighting system, according to one or more embodiments.

FIG. 2A illustrates a front isometric view of a canopy light of the lighting system of FIG. 1, according to one or more embodiments.

FIG. 2B illustrates an exploded view of the canopy light of FIG. 2A, according to one or more embodiments.

FIG. 3A illustrates an exploded view of a mounting assembly of the lighting system of FIG. 1, according to one or more embodiments.

FIG. 3B illustrates a side view of the lighting system of FIG. 1 attached to a canopy frame, according to one or more embodiments.

### DETAILED DESCRIPTION OF THE FIGURES

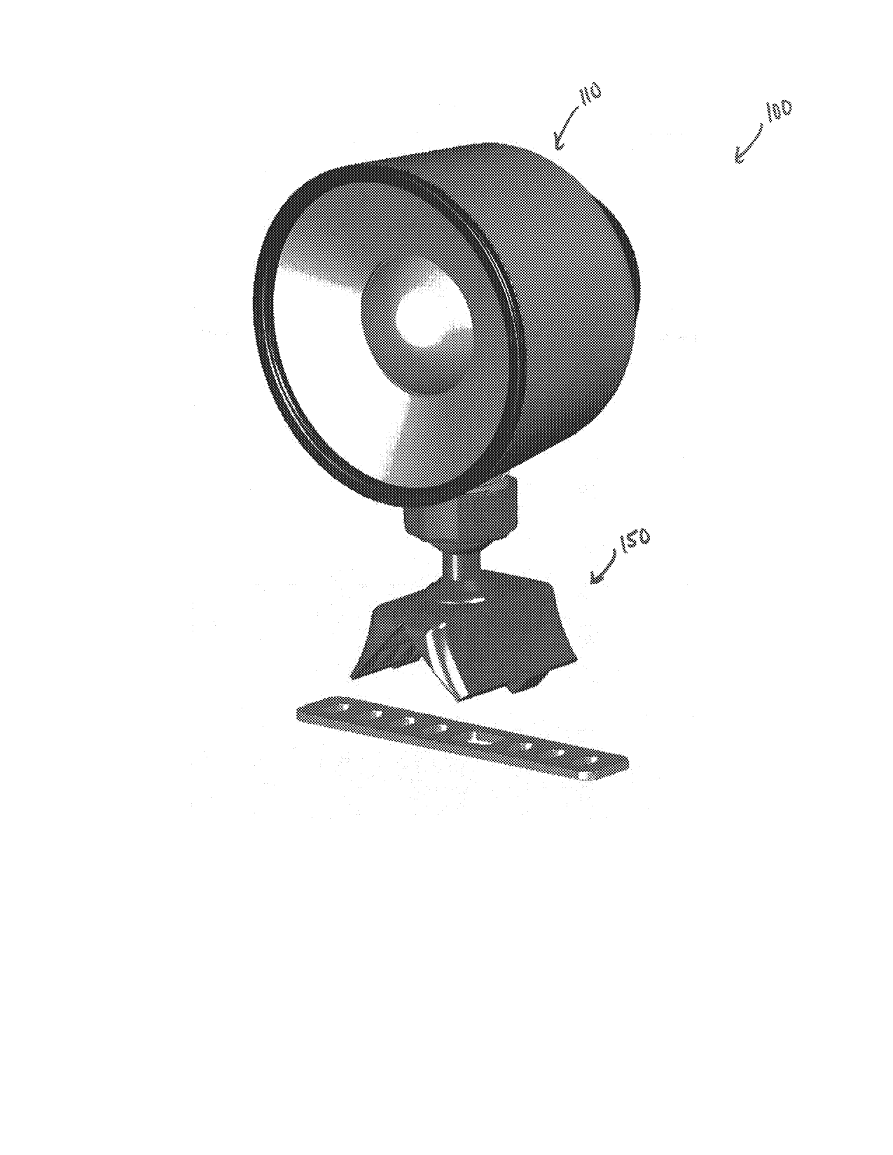

Referring generally to FIGS. 1-3B, embodiments of a lighting system are disclosed. Embodiments disclosed herein provide comprehensive lighting systems for overhead structures, such as canopies, tents, awnings, shades, and other coverings used in outdoor and/or low-light applications. Embodiments disclosed herein incorporate dual-beam illumination capabilities, removable attachment systems, and advanced operational modes to enhance visibility and functionality during outdoor activities and/or in low-light conditions.

FIG. 1 is a front isometric view of a lighting system or "system" 100, in accordance with one or more embodiments. The system 100 may be used with a canopy or other overhead covering, as described above, for use in various outdoor applications including tailgating events, farmer's markets, camping trips, outdoor festivals, beach gatherings, backyard parties, construction sites, emergency shelters, recreational vehicle awnings, and other temporary or portable shelter applications where enhanced illumination is desired.

As illustrated, the system 100 includes a canopy light 110 operable provide illumination in a plurality of lighting modes, as will be described in more detail below. The system 100 may be adjusted to provide a comprehensive range of illumination capabilities including variable intensity control from low ambient lighting to high-intensity task illumination, multiple color temperature options ranging from warm white to cool white, and selectable beam patterns including focused spotlight and wide-angle floodlight configurations. The system 100 further includes a mounting assembly 150 that is coupled to the canopy light 110 and that is configured to attach the system 100 to an article, such as to a frame or structural member of a canopy, as will be described in more detail below.

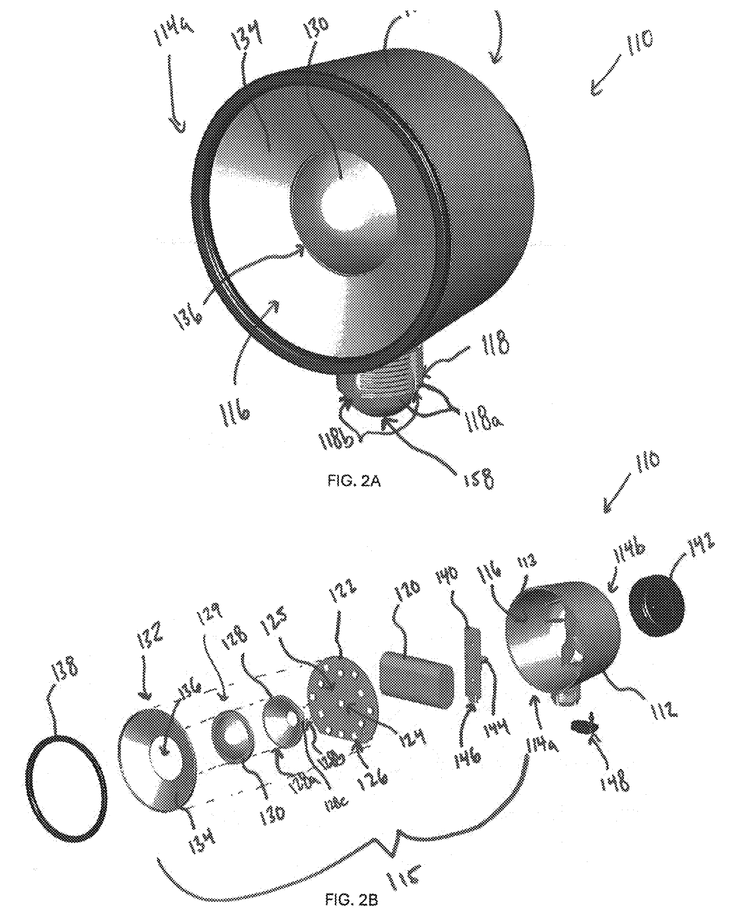

FIG. 2A illustrates a front isometric view of the canopy light 110 of FIG. 1, in accordance with one or more embodiments. As illustrated, the canopy light 110 includes a body 112 having a first end 114a and a second end 114b positioned opposite the first end 114a. The body 112 may be constructed from Acrylonitrile Butadiene Styrene (ABS) or other polymers, such as Polyethylene (PE) or Polypropylene (PP), may be opaque, and may provide durability and weather resistance while exhibiting a configuration that optimizes both functionality and mounting compatibility with various outdoor structures.

In the illustrated embodiment, the body 112 exhibits a generally cylindrical shape where the first and second ends 114a,b exhibit the same, or substantially the same, diameters. However, the body 112 may exhibit other shapes and geometric configurations without departing from the scope of this disclosure. For example, the body 112 may be a generally conical shape where the first end 114a exhibits a first diameter and the second end 114 exhibits a second diameter that is different (less than) the first diameter. The body 112 further defines a cavity 116 that extends between the first end 114a and the second end 114b. The body 112 provides a secure and weather-resistant housing for various electrical and optical components used in the operation of the canopy light 110, as will be described in more detail below.

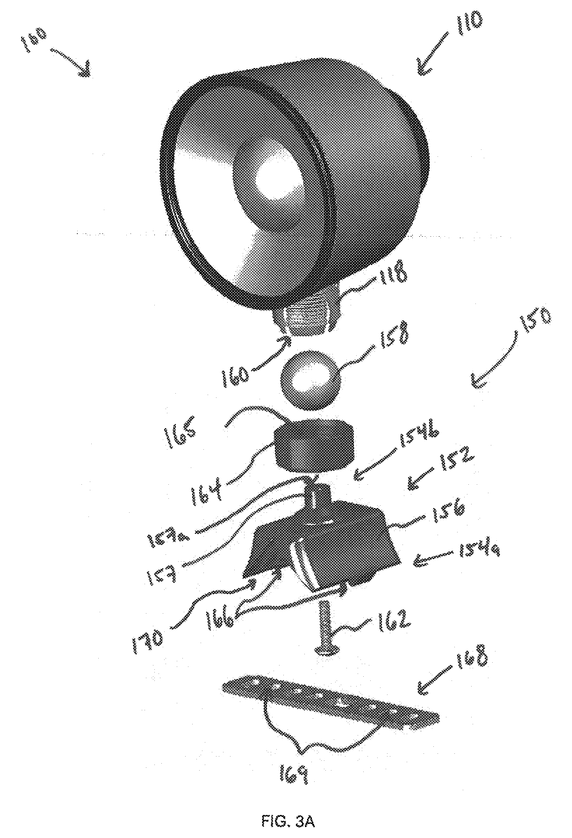

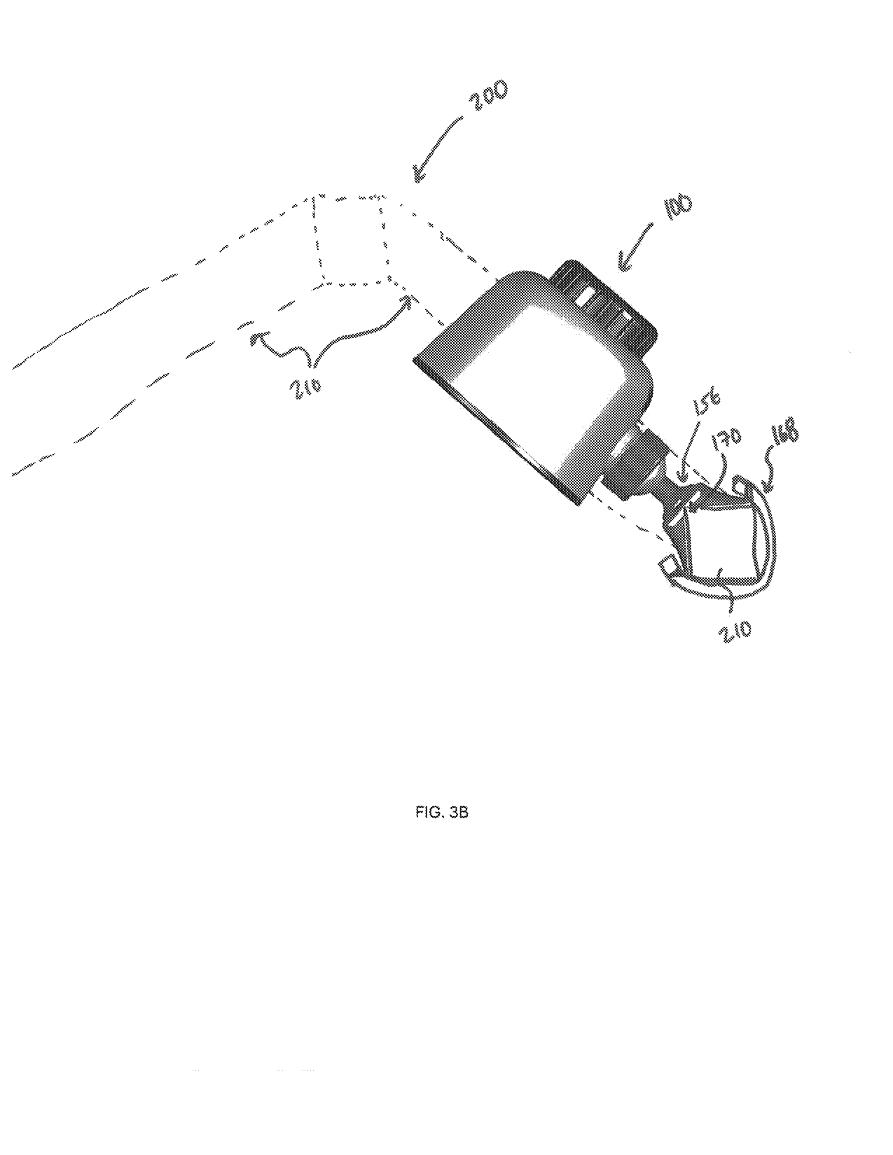

As further illustrated in FIG. 2A, the canopy light 110 includes a connector 118 that facilitates attachment of the canopy light 110 to the mounting assembly 150, as will be described in more detail below. The connector 118 includes a plurality of (e.g., 4) flanges 118a that are radially (angularly) offset from one another with gaps 118b defined therebetween. The connector 118 defines a recess or “socket” 160 (see FIG. 3A) that is encircled by the flanges 118a and that is operable to receive a ball joint 158 therein. In other embodiments, the connector 118 may include more than 4 flanges (e.g., 5, 6, or 7 flanges) or less than 4 flanges (e.g., 2 or 3 flanges).

FIG. 2B illustrates an exploded view of the canopy light 110, in accordance with one or more embodiments. As illustrated, the canopy light 110 includes a plurality of internal components 115 that are arranged within the cavity 116, such as in a linear stack. Other configurations and arrangements of the internal components 115 are contemplated without departing from the scope of this disclosure.

The internal components 115 include a power supply 120 operable to supply electrical power to various components of the canopy light 110, as will be described in more detail below. The power supply 120 may be an internal power source, enabling the system 100 to be used as a packaged unit without external electrical connections.

The power supply 120 may be rechargeable and, accordingly, may include a variety of battery technologies, such as lithium ion, lithium polymer, nickel-metal hydride (NiMH), nickel-cadmium (NiCd), or other suitable rechargeable battery chemistries. In some embodiments, the power supply 120 may include two 18650 4400mAh lithium ion batteries, though other voltage and capacity configurations are contemplated within the scope of this disclosure.

In some embodiments, the body 112 includes a plurality of structural features (e.g., protrusions, tracks, rails, etc. (not shown)) extending into the cavity 116 and that are operable to receive and securely house the power supply 120 and/or one or more other internal components 115 of the canopy light 110. The structural features may be shaped and sized to accommodate various geometries of the internal components 115. For example, the power supply 120 is illustrated exhibiting a generally rectangular shape, so the body 112 may include generally rectangular structural features to securely receive edges of the power supply 120.

In some embodiments, the canopy light 110 may include an external power supply electrically connected to the canopy light 110 through various external power connections. The external power supply may supply power to the canopy light 110 as an alternative or in addition to the power supply 120. External power supplies may include AC adapters, DC power supplies, solar panels, portable battery packs, vehicle power outlets (12V/24V), USB power banks, or mains power connections. The body 112 may define a port for receiving power from such external sources, with the port being electrically connected to the internal components through appropriate power management circuitry. External power connections may utilize various connector types including barrel connectors, USB-C ports, Anderson Powerpole connectors, cigarette lighter adapters, weatherproof aviation connectors, or hardwired terminal blocks, depending on the specific application requirements and environmental conditions.

In some embodiments, the power supply 120 provides the canopy light 110 with a runtime of 6 to 44 hours depending on the operational mode and brightness settings, ensuring extended operation during outdoor activities. In other embodiments, however, the power supply 120 may supply more than 44 hours of runtime, such as 50 hours, 55 hours, or 60 hours, for example.

The internal components 115 further include one or more printed circuit boards (PCBs) that are securable (arrangeable) within the cavity 116 and electrically couplable to the power supply 120 to receive power therefrom. In the illustrated embodiment, the canopy light 110 includes a first or "illuminating" PCB 122 to which one or more light sources, discussed in more detail below, are coupled (mounted). As shown, the illuminating PCB 122 is positionable in the cavity 116 directly adjacent to the power supply 120. However, in other embodiments, the illuminating PCB 122 may be spaced apart from the power supply 120 within the cavity 116. In some embodiments, the body 112 includes structural features configured to receive edges of the illuminating PCB 122 to thereby centrally align and secure the illuminating PCB 122 within the cavity 116.

The internal components 115 further include a first light source 124 or “spotlight” mounted to a first side (e.g., a front side) of the illuminating PCB 122. In the illustrated embodiment, the first light source 124 includes a single surface-mount device (SMD) light mounted to a center of the illuminating PCB 122 and that is operable to emit a first beam of light through the first end 114a of the body 112. The first beam of light may be a concentrated beam of light operable to illuminate a centralized area in front of the canopy light 110. In other embodiments, the first light source 124 may include more than one SMD light (e.g., 2, 3, 4, or 5 SMDs). In some embodiments, the first light source 124 may emit light with an output of 1000 lumens at peak brightness, which may provide sufficient illumination for outdoor applications while maintaining optimal battery life. In other embodiments, the first light source 124 may emit light with an output of less than 1000 lumens at peak brightness (e.g., 500, 750, or 900 lumens), or more than 1000 lumens at peak brightness (e.g., 1250, 1500, or 1750 lumens).

The internal components 115 further include a second light source 126 or “floodlight” that is also mounted to the first side of the illuminating PCB 122 and positioned radially around the first light source 124. In the illustrated embodiment, the second light source 126 includes a plurality of (e.g., 12) SMD lights that are operable to emit light in a second beam of light through the first end 114a of the body 112 that is larger in diameter than the first beam of light. For instance, at the first end 114a, the first beam of light from the first light source 124 may exhibit a first diameter and the second beam of light from the second light source 126 may exhibit a second diameter greater than the first diameter. Accordingly, the second beam of light may be a diffusive beam of light operable to illuminate a wide area in front of the canopy light 110 (e.g., wider than the area illuminated by the first beam of light). In other embodiments, the second light source 126 may include less than 12 SMD lights (e.g., 4, 6, 8, or 12 SMD lights) or more than 12 SMD lights (e.g., 14, 16, 18, or 20 SMD lights). In some embodiments, the second light source 126 may emit light with an output of 500 lumens at peak brightness, which may provide enhanced area illumination for outdoor activities while maintaining optimal battery life. In other embodiments, the second light source 126 may emit light with an output of less than 500 lumens at peak brightness (e.g., 100, 250, or 400 lumens), or more than 5000 lumens at peak brightness (e.g., 7250, 1000, or 1250 lumens). The second light source 126 may emit light with an output (e.g., lumens) that is different (less than or greater than) the output of the first light source 124. Alternatively, the second light source 126 may emit light with an output that is the same as the first light source 124.

In some embodiments, each of the first and second light sources 124, 126 may include one or more discrete light-emitting diodes (LEDs), one or more flexible light strips, such as chip-on-board (COB) light strips, LED light strings, or other suitable illumination technologies, or combinations thereof. The light sources 124, 126 may be operable to emit various colors including white, warm white (3500K), RBG, or combinations thereof for enhanced visibility and customization options.

The second light source 126 may be mounted to a "periphery" or a "ring" of the illuminating PCB 122 or mounted "in" or "about" a "periphery" or "ring" of the first light source 124 (e.g., "around" the first light source 124). In embodiments including SMDs and/or LEDs, the second light source 126 may provide discrete lighting elements in a ring, which may define a variety of geometries, such as circular or square patterns. In embodiments including flexible light strips (e.g., COB lights), the second light source 126 may define a continuous ring.

As illustrated, a radial gap 125 may be defined between the first and second light sources 124, 126 on the illuminating PCB 122 to provide spatial separation between the corresponding first and second beams of light. As further illustrated in FIG. 2B, the internal components 115 further include a cone 128 positioned directly adjacent the illuminating PCB 122 and that may be secured within the cavity 116. The cone 128 includes a first end 128a exhibiting a first diameter and a second end 128b opposite the first end that exhibits a second diameter different (less than) the first diameter. The second end may contact the illuminating PCB 122 between the first and second light sources 124, 126 at the gap 125.

The cone 128 is operable to direct light emitted from the first light source 124 in a first area toward the first end 114a and, furthermore, is operable to restrict light emitted from the second light source 126 from entering the first area. Similarly, the cone 128 is operable to direct light emitted from the second light source 126 in a second area toward the first end 114a and, furthermore, is operable to restrict light emitted from the first light source 124 from entering the second area. The cone 128, thus, functions to isolate and distinguish the first and second beams of light emitted from the respective first and second light sources 124, 126. In some embodiments, the cone 128 is constructed from ABS or other polymers, such as Polyethylene (PE) or Polypropylene (PP). The cone 128 may also include a silver or reflective finish to optimize light direction and focus of the first and second beams of light from the first and second light sources 124, 126, respectively.

The internal components 115 further include a first or "spotlight" lens 130 operable to focus light (e.g., the first beam of light) emitted from the first light source 124. The spotlight lens 130 may be positioned in front of the cone 128 (e.g., closer to the first end 114a when compared to the cone 128) such that the cone 128 is captured between the illuminating PCB 122 and the spotlight lens 130. The spotlight lens 130 may exhibit a diameter that is the same, or substantially the same, as the first diameter of the first end 128a of the cone 128. The spotlight lens 130 may diffuse light that is emitted from the first light source 124 through the cone 128. The first lens 130 may be convex and, in some embodiments, may be constructed from an acrylic material. In other embodiments, the first lens 130 is concave.

The internal components 115 further include a second or "floodlight" lens 132 operable to focus light (e.g., the second beam of light) emitted from the second light source 126. The floodlight lens 132 includes a ring 134 or “periphery” extending radially outward from the first diameter (e.g., from an outer surface of the spotlight lens 130) to an inner surface 113 of the body 112. In some embodiments, the cone 128 directs light emitted from the second light source 126 through an annulus 129 defined radially between an outer surface 128c of the cone and the inner surface 113 of the body and longitudinally between the illuminating PCB 122 and the second lens 132. The annulus 129 defines a variable width along the length of the cone 128 and may have the same or a substantially similar width as the periphery 134 at the first end 128a of the cone 128. In such embodiments, the light emitted from the second light source 126 passes through the annulus 129 and the periphery 134 to provide floodlight illumination through the first end 114a. The floodlight lens 132 may be concave or convex and, as shown, may exhibit a generally circular shape. However, other configurations and geometries are contemplated herein.

The floodlight lens 132 defines a central hole 136 within the periphery 134 for receiving the spotlight lens 130 therein, as shown in FIG. 2A. More specifically, the central hole 136 may exhibit a diameter that is the same, or similar, to the diameter of the spotlight lens 130. In some embodiments, the spotlight lens 130 is secured within the central hole 136 via an interference fit. In such embodiments, the floodlight lens 132 may surround the spotlight lens 130. However, the spotlight lens 130 may be secured within the central hole 136 or, more generally, within the cavity 116 by other methods known in the art, including adhesive bonding, ultrasonic welding, snap-fit mechanisms, threaded engagement, press-fit assembly, mechanical clips or retainers, O-ring seals with compression fitting, bayonet mount connections, or twist-lock assemblies, without departing from the scope of this disclosure. The spotlight and floodlight lenses 130, 132 may each comprise a single lens having a discrete outer and inner portion that is operable to provide both spotlight and floodlight functionality. In other embodiments, the cone 128 may be integral with either or both of the spotlight and floodlight lenses 130, 132.

The canopy light 110 may further include a locking ring or "lens lock" 138 operable to secure the floodlight lens 132 to the body 112 at the first end 114a, thereby securing the internal components 115 within the cavity 116. The lens lock 138 may be sonic welded to the body 112 to fluidly seal the cavity 116, thereby preventing water, air, and debris from entering the cavity 116 and damaging the internal components 115 of the canopy light 110.

The internal components 115 further include a second or "control" PCB 140 that may be arranged between the power supply 120 and the second end 114b. The second PCB 140 may be in electrical communication with the power supply 120 to receive power therefrom. The second PCB 140 may be in operable communication with the first PCB 122 to control the first and second light sources 124, 126.

The canopy light 110 may further include a dial 142 that may be coupled to the second PCB 140. For instance, as shown, the control PCB 140 provides an actuator 144, such as a button, that may rotatable and depressible relative to the control PCB 140 to control one or more operational modes of the illumination PCB 122. The actuator 144 may extend through a bore 149 in the second end 114b (occluded from view) and may be received by the dial 142 to define a friction fit therebetween. Accordingly, the user may actuate (control) the actuator 144 via the dial 142. For instance, a user may depress the dial 142 to actuate the actuator 144 (e.g., a first type of actuation) to perform a first function (e.g., toggle between one or more power modes, as will be described in more detail below) or rotate the dial 142 to actuate the actuator (e.g., a second type of actuation different than the first type of actuation) to perform a second function different than the first function (e.g., adjust the brightness of light emitted from the first and second lights sources 124, 126).

In some embodiments, the illuminating and control PCBs 122, 140 may be toggleable between a plurality of power modes which may include a first power mode, a second power mode, a third power mode, and a fourth power mode. In the first power mode, the PCBs 122, 140 may cause both the first light source 124 and the second light source 126 to emit light (e.g., the first and second beams of light). In the second power mode, the PCBs 122, 140 may cause the first light source 124 to emit light and the second light source 126 to abstain from emitting light (is “off”). In the third power mode, the PCBs 122, 140 may cause the second light source 126 to emit light and the first light source 124 to abstain from emitting light (is “off”). In the fourth power mode, the PCBs 122, 140 may cause both the first and second light sources 124, 126 to abstain from emitting light. The dial 142 may selectively be actuated (e.g., depressed) to toggle the PCBs 122, 140 between the plurality of power modes (e.g., one press for first power mode; two presses for second power mode; three presses for third power mode; four presses for fourth power mode).

Moreover, the dial 142 may be rotated relative to the body 112 to cause rotation of the actuator 144 relative to the control PCB 140. The control PCB 140 may include a variable resistor adjustable by rotation of the actuator 144 to control the outgoing brightness of both the first and second light sources 124, 126. The variable resistor may be a rheostat, a potentiometer, a rotary encoder, a digital potentiometer, a trimmer resistor, a slide potentiometer, a multi-turn potentiometer, a logarithmic taper potentiometer, a linear taper potentiometer, or other variable resistance device configured to provide continuous or stepped brightness control through rotational or linear adjustment mechanisms.

A recharge port 146 may be mounted to one or both of the first or second PCB 122, 140 to enable recharging of the power supply 120. The recharge port 146 may receive various charging cables and connectors, including USB-C charging interfaces for universal compatibility. In some embodiments, a charging cable coupled to the recharge port 146 may recharge the power supply 120 while also providing electrical power to the internal components 115 directly from an external power supply. In some embodiments, the recharge port 146 may be a power port operable to communicate electrical energy from an external power supply to the canopy light 110.

The recharge port 146 may be accessible through a corresponding opening (occluded from view) defined in the body 112. A port cover 148 may be provided to cover and opening, thereby preventing fluid intruding into the cavity 116 and into contact with the recharge port 146. The port cover 148 may be constructed from silicone material that provides weather-resistant sealing while allowing easy access for charging operations.

In addition to the lighting modes and operational controls described above, the canopy light 110 may be programmed to provide various lighting patterns, such as continuous illumination, slow pulse, fast strobe, and color-cycling patterns for enhanced visibility and customization in diverse outdoor environments.

Referring now to FIG. 3A, an exploded view of the mounting assembly 150 of the canopy light 110 is shown, in accordance with one or more embodiments. As illustrated, the mounting assembly 150 includes a mounting bracket 152 having a first end 154a and a second end 154b opposite the first end 154a. The first end 154a defines a notch 170 that is operable to interface with a frame of a canopy, as explained in more detail below, and the second end 154b provides a post 157. An aperture 157a is defined in the mounting bracket 152 and extends from the notch 170 through the post 157. The ball joint 158 may define a recess (occluded from view) and threads (e.g. female threads) in the recess. The ball joint 158 may contact (sit) on the post 157. The mounting assembly 150 may further include a fastener 162 (e.g., a bolt) that is extendable through the aperture 157a and into the recess of the ball joint 158. The fastener 162 may include threads (e.g., male threads) that may threadably couple with the threads in the recess of the ball joint 158 to secure the ball joint 158 to the mounting bracket 152, holding the ball joint 158 against the post 157.

The mounting assembly 150 may further include a ball lock 164 that defines a recess 165 sized to receive the connector 118 therethrough and that includes threads (e.g. female threads) for threadably coupling with the connector 118 via threads (e.g., male threads) provided on the flanges 118a. Threadably coupling the ball lock 164 to the connector 118 may prevent the flanges 118a from splaying (flexing) away from one another, thereby preventing the ball joint 158 from escaping the socket 160.

Accordingly, when the ball joint 158 is received and secured within the socket 160, as described above, a joint may be defined between the canopy light 110 and the mounting bracket 152 that allows the canopy light 110 to rotate relative to mounting bracket 152 in three (rotational) degrees of freedom.

As further illustrated in FIG. 3A, the base portion 156 includes two flanges 166 extending outwards from the first end 154a. The mounting assembly 150 further includes an attachment band 168 defining apertures 169 sized to receive the flanges 166. The attachment band 168 may be made of a flexible material, such as rubber or any other suitable elastic material, that allows the attachment band to stretch and wrap around structures of varying sizes, as described in more detail below.

FIG. 3B illustrates a side view of the system 100 attached to a frame 210 of a canopy 200, in accordance with one or more embodiments. The frame 210 may be a leg, a cross-member, a support, or other structural member of the canopy 200. As shown, the frame 210 exhibits a rectangular cross-section. Accordingly, the notch 170 exhibits a rectangular shape to receive the rectangular frame 210 of the canopy 200. Depending on the specific configuration and shape of the frame 210, the notch 170 may exhibit other shapes and geometric configurations to accommodate various frame cross-sections, including circular, oval, triangular, hexagonal, or other polygonal shapes commonly used in canopy and tent frame construction.

Once the base portion 156 is seated on the frame 210 (e.g., the frame 210 received within the notch 170) at a desired orientation, a first one of the flanges 166 may be received within a first aperture 169 at a first end of the attachment band 168, thereby securing a first end of the attachment band 168 to the mounting bracket 152. A second end of the attachment band 168 opposite of the first end may then be stretched about the frame 210, and a second aperture 169 at the second end of the attachment band 168 may receive a second one of the flanges 166, thereby securing the mounting bracket 152 to the canopy 200. The canopy light 110 may then be allowed to rotate and swivel relative to the mounting bracket 152 via the joint, as discussed above.

According to embodiments disclosed herein, the system 100 incorporates weather-resistant features through the use of silicone sealing components and covers, enabling reliable operation in variable outdoor conditions including rain, humidity, and temperature variations commonly encountered during outdoor use. The mounting assembly 150 further enables secure mounting to different structures while maintaining the ability to remove and reattach the lighting assembly as needed for charging or storage, thereby providing both security and convenience for the user.

According to embodiments disclosed herein, the canopy light 110 enables tool-free installation and incorporates rechargeable power supplies with USB-C charging capability for user convenience and universal compatibility. The lighting system 100 represents a comprehensive solution for outdoor illumination that addresses multi-directional lighting requirements while providing advanced features such as multiple lighting modes, weather resistance, and convenient mounting systems that enhance the overall functionality and usability of the outdoor lighting solution.

While this invention has been shown and described with respect to a detailed embodiment or embodiments thereof, it will be understood by those skilled in the art that changes in form and detail thereof may be made without departing from the scope of the claims of the invention.

What is claimed is:

1. A lighting assembly for a canopy, comprising:
a body extending between a first end and a second end opposite the first end, wherein the body defines a cavity;
a first lens disposed in the cavity;
a second lens disposed in the cavity at the first end of the body and defining a central opening, wherein the first lens is positioned in the central opening;
a first light source configured to emit light through the first lens to provide a forward-facing spotlight; and
a second light source configured to emit light through the second lens to provide a forward-facing flood light.

2. The lighting assembly of claim 1, further comprising a rechargeable power supply receivable within the cavity and electrically connected to the first and second light sources.

3. The lighting assembly of claim 1, further comprising a port for receiving an external power supply accessible through an opening defined in the body, the port being electrically connected to the first and second light sources.

4. The lighting assembly of claim 1, wherein the first light source and the second light source are mounted to a printed circuit board (PCB), and wherein the second light source is positioned around the first light source.

5. The lighting assembly of claim 1, wherein the first light source is a surface-mount device (SMD) light mounted to a center of a printed circuit board (PCB), and wherein the second light source includes a plurality of SMDs mounted to the PCB around the first light source, wherein a gap is defined on the PCB between the first and second light sources.

6. The lighting assembly of claim 1, wherein the second lens is configured to diffuse light about a periphery of the first lens.

7. The lighting assembly of claim 1, further comprising a cone disposed within the cavity, the cone having a first end and a second end opposite the first end, wherein the second end is positioned radially between the first and second light sources and is configured to restrict light emitted from the second light source from passing through the first lens.

8. The lighting assembly of claim 1, wherein the first lens is secured in the central opening via interference fit.

9. The lighting assembly of claim 1, further comprising a locking ring coupled to the body and configured to secure the second lens to the body.

10. The lighting assembly of claim 9, wherein the locking ring is secured to the body via a sonic weld and is configured to fluidly seal the cavity.

11. A lighting assembly, comprising:
a body defining a cavity and including a connector defining a socket;
a lens including a first portion and a second portion disposed in the cavity, wherein the second portion surrounds the first portion;
a first light source arranged in the cavity and configured to emit light through the first portion;
a second light source arranged in the cavity and configured to emit light through the second portion; and
a mounting assembly including:
a ball joint positioned in the socket, thereby defining a joint; and
a mounting bracket coupled to the ball joint.

12. The lighting assembly of claim 11, wherein the connector includes a plurality of flanges radially spaced apart from one another.

13. The lighting assembly of claim 12, wherein the mounting assembly further includes a ball lock coupled to the connector to prevent the flanges from flexing relative to one another.

14. The lighting assembly of claim 11, wherein the mounting bracket includes a post and defines an aperture extending through the post, wherein the ball joint is seatable on the post and defines a recess that includes first threads, wherein the mounting assembly further includes a fastener that includes second threads, and wherein the fastener is extendable through the aperture and into the recess to threadably couple the first and second threads.

15. The lighting assembly of claim 11, wherein the mounting bracket extends between a first end and a second end opposite the first end, the ball joint being securable to the first end of the mounting bracket via a fastener, and the canopy being securable to the second end of the mounting bracket via an attachment band.

16. A lighting assembly, comprising:
a body defining a cavity;
a lens including a first portion and a second portion disposed in the cavity, wherein the second portion surrounds the first portion;
a first light source arranged in the cavity and configured to emit light through the first portion, and
a second light source arranged in the cavity and configured to emit light through the second portion;
wherein the first and second light sources are toggleable between a plurality of a power states, including:
a first power state in which the first light source emits light through the first portion and the second light source abstains from emitting light;
a second power state in which the second light source emits light through the second portion and the first light source abstains from emitting light;
a third power state in which the first and second light sources emit light through the first and second portions simultaneously; and
a fourth power state in which the first and second light sources both abstain from emitting light.

17. The lighting assembly of claim 16, further comprising a PCB in electrical communication with the first and second light sources, wherein the PCB includes an actuator operable to control the first and second light sources.

18. The lighting assembly of claim 17, wherein the PCB is operable to control a brightness of the first and second light sources based on a first type of actuation of the actuator.

19. The lighting assembly of claim 18, wherein the PCB is operable to switch the first and second power sources between the plurality of power states based on a second type of actuation of the actuator different than the first type of actuation.

20. The assembly of claim 16, wherein the first and third power states provide spotlight illumination through the first end of the body, and wherein the second and third power states provide floodlight illumination through the first end of the body.
